(19) United States
(12) Patent Application Publication
(10) Pub. No.: US 2014/0083088 A1
(43) Pub. Date: Mar. 27, 2014

(54) METHOD AND SYSTEM FOR COMPENSATION OF AN INSUFFICIENT PRESSURE BUILDUP IN THE BRAKING SYSTEM OF A VEHICLE

(71) Applicants: Rafael Gonzalez Romero, Ilsfeld-Auenstein (DE); Thomas Bruex, Oberstenfeld (DE); Sabrina Dittrich, Murr (DE); Otmar Bussmann, Abstatt (DE)

(72) Inventors: Rafael Gonzalez Romero, Ilsfeld-Auenstein (DE); Thomas Bruex, Oberstenfeld (DE); Sabrina Dittrich, Murr (DE); Otmar Bussmann, Abstatt (DE)

(21) Appl. No.: 14/006,855

(22) PCT Filed: Jan. 27, 2012
(86) PCT No.: PCT/EP2012/051319

§ 371 Date: Dec. 6, 2013

(30) Foreign Application Priority Data
Mar. 23, 2011 (DE) 102011005984.90

(51) Int. Cl. F15B 13/02

(52) U.S. Cl. CPC F15B 13/02
USPC 60/327; 60/431

(57) ABSTRACT

A method is described for compensation of an insufficient pressure buildup in the braking system of a vehicle in the event of a failure or malfunction of a brake booster for brake force support when an actuating element of the braking system is actuated, the compensation occurring with the aid of a unit for an additional pressure buildup in the braking system and triggering of this compensation occurring as a function of a position of the actuating element in its adjustment travel. An instantaneous position of the actuating element in the adjustment travel is ascertained continuously or periodically, and the triggering and the additional pressure build-up occur as a function of this ascertained instantaneous position. Also described is a corresponding compensating system.

### FIELD OF THE INVENTION

The present invention relates to a method and system for compensation of an insufficient pressure buildup in the braking system of a vehicle.

### BACKGROUND INFORMATION

The braking system of a vehicle, in particular a motor vehicle, functions to reduce the speed of the vehicle, to bring it to a standstill or to keep it at a standstill. The braking system has at least one actuating device which initiates and controls the action in the braking system. This actuating device, for example, a brake pedal, is mechanically operable by the user/driver of the vehicle. A brake booster increases the force applied by the driver during actuation of the actuating device and thus reduces the necessary exertion of force. In most passenger vehicles, this brake booster in combination with a main brake cylinder is part of the braking system of the passenger vehicle. A typical design of a brake booster is the vacuum brake booster system; a hydraulic brake booster system is used less frequently.

A vehicle dynamics control system or electronic stability control (ESC), which is often referred in German-speaking countries as an electronic stability program (ESP), denotes an electronically controlled driver assistance system for motor vehicles, which counteracts the swerving of a vehicle through targeted braking of individual wheels. For this purpose, the driver assistance system has an ESP unit. Part of the vehicle dynamics control system also includes additional functions, among other things. One additional function here is a compensation system which intervenes in the event of the failure or malfunction of the brake booster (for example, the hydraulic boost failure compensation (HBC) function in Bosch ESP).

Various vehicles today use a method in which the driver is assisted by a regulated active pressure buildup in the event of failure or malfunction of the brake booster. However, this pressure buildup may occur only when it has been confirmed that the driver has actually actuated the braking system with the aid of the actuating device. In one of today's embodiments of this method, the measured prepressure of the ESP unit and the signal of the stop light switch (SLS) are used together as an adequate criterion for triggering the pressure compensation.

The compensation is activated only when the signal of the prepressure measurement in the braking system exceeds a certain threshold value (e.g., 2 bar) and the stop light switch has been turned on, i.e., a fixed triggering position as the adjustment travel threshold has been exceeded by the actuating element in its adjustment travel. This prevents an unwanted pressure buildup and thus an unwanted deceleration in the event of a pressure offset or in the event of a defect in the stop light switch. Through this additional coupling of the triggering with the stop light switch, a fixedly predetermined triggering position of the actuating element must be reached or exceeded. For example, if there is a failure of the brake booster, then a relatively strong force must be exerted.

### SUMMARY

The method according to the present invention and the compensation system according to the present invention offer the advantage that the exertion of force on the actuating element for triggering of the compensation is reduced.

It is provided in the method according to the present invention that an instantaneous position of the actuating element is ascertained continuously or periodically and that the triggering as well as the additional pressure buildup occur as a function of this ascertained instantaneous position. The instantaneous position of the actuating element thus also has an influence on the intensity of the pressure buildup. Since the instantaneous position of the actuating element is ascertained continuously or at least regularly and not only at a point in time or a time interval when the actuating element has reached or exceeded a fixed triggering position, additional effects of the failure or malfunction of the brake booster may also be compensated. Furthermore, the position of the actuating element may be ascertained without being influenced by the hydraulic boosting.

The method is preferably implemented within the scope of a compensation system which intervenes in the event of a failure or a malfunction of the brake booster (HBC: hydraulic boost failure compensation). This compensation assists the user/driver after triggering in any braking operations. Such compensation is important in particular when the actuating element is actuated very powerfully since in this case full deceleration is desired, which is probably not achieved without compensation. In such a very powerful actuation of the actuating element, a brake pressure greater than 30 bar in particular should be built up.

In one preferred embodiment of the present invention, it is provided that compensation is triggered when the instantaneous position reaches or exceeds a predefinable triggering position in the adjustment travel. This triggering position is predefined by an offset comparison in particular. The specification of the triggering position may take into account the degree of malfunction of the brake booster, for example.

If a malfunction or even a failure of the brake booster is detected (for example, by detecting a slight vacuum or a booster fault) and if the instantaneous position has reached or exceeded a predefinable triggering position in the adjustment travel, then an active pressure buildup is initiated with the aid of the ESP unit.

In addition to the instantaneous position of the actuating element in particular, a pressure in the braking system allocated to the position is ascertained continuously or periodically and the triggering position is determined as a function of the pressure.

According to another advantageous embodiment of the present invention, it is provided that the compensation occurs by a vehicle dynamics control system of a driver assistance system in the vehicle. Within the scope of the electronic stability program (ESP) of a motor vehicle, a unit (ESP unit) having one or multiple pumps is provided, pumping additional brake fluid into one or multiple particular brake cylinders of the braking system after triggering and thus (further) increasing the brake pressure in the brake cylinder(s).

According to one advantageous embodiment of the method according to the present invention, the compensation also occurs as a function of a prepressure of the braking system. In addition to the ascertained instantaneous position of the actuating element, the prepressure of the braking system also enters into the pressure buildup. If the prepressure is lower than a threshold value, then an active pressure buildup occurs up to a predefinable maximum pressure, which corresponds to a tolerable deceleration. If the prepressure is greater than or equal to this threshold value, then an active pressure buildup occurs as a function of the prepressure.

According to another advantageous embodiment of the present invention, it is provided that the actuating element is a pedal. In motor vehicles, the usual design of the actuating element is a pedal. In addition, the corresponding sensor is a pedal travel sensor.

In another preferred embodiment of the present invention, it is provided that the pressure buildup by the unit after the triggering during an adjustable period of time is limited. This is an additional safety aspect.

In the system according to the present invention it is provided that this system has a sensor for continuously or periodically ascertaining an instantaneous position of the actuating element in its adjustment travel and a device for controlling and/or regulating the unit as a function of an ascertained instantaneous position.

In one preferred embodiment of the present invention, it is provided that the system is part of a driver assistance system of the vehicle; in particular it is an additional function of this driver assistance system. This driver assistance system has the ESP unit. The compensation system, which intervenes in the event of a failure or malfunction of the brake booster system, is the hydraulic boost failure compensation (HBC) system in the Bosch ESP, for example.

According to one advantageous embodiment of the present invention, it is provided that the device for triggering the compensation also receives an input signal proportional to the prepressure of the braking system.

According to another advantageous embodiment of the present invention, it is provided that the actuating element is a pedal. In motor vehicles, the usual design of the actuating element is a pedal. In addition, the corresponding sensor is a pedal travel sensor.

### BRIEF DESCRIPTION OF THE DRAWINGS

FIG. 1 shows a schematic diagram of a system for compensation of an insufficient pressure buildup in the braking system of a motor vehicle according to one preferred specific embodiment of the present invention.

FIG. 2 shows a flow chart of one particularly preferred specific embodiment of the method according to the present invention.

### DETAILED DESCRIPTION

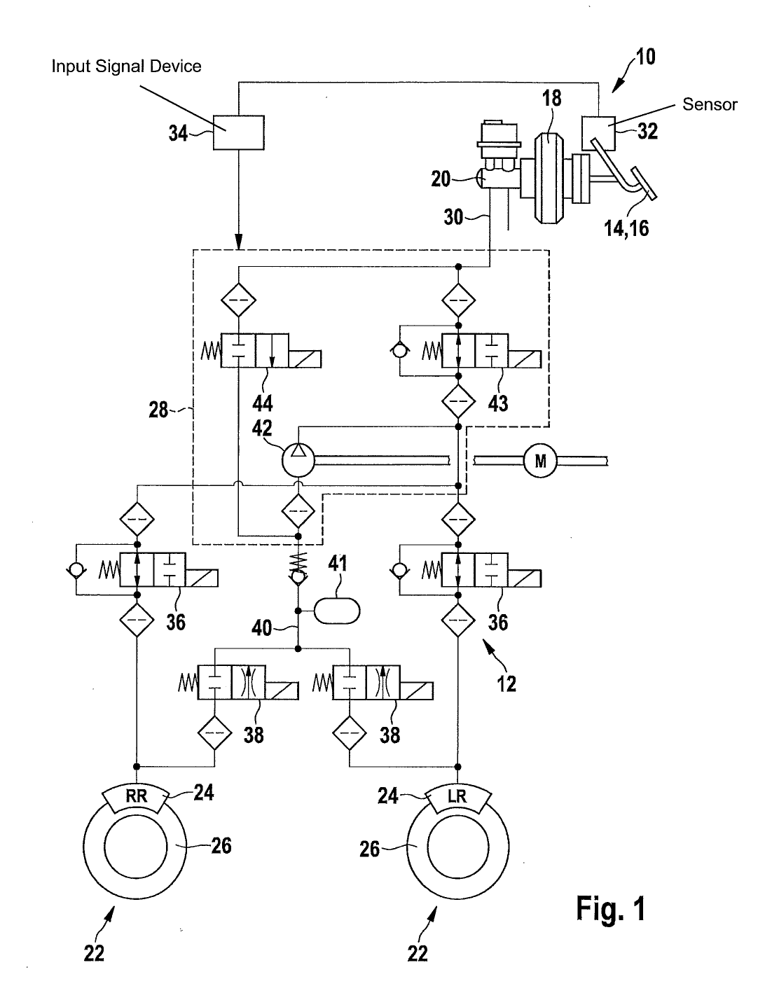

FIG. 1 shows the basic design of a compensation system 10 for compensation of an insufficient pressure buildup in braking system 12 of a vehicle (vehicle not shown as a whole). Braking system 12 has an actuating element 16, designed as a brake pedal 14, a brake booster 18, a main cylinder 20, wheel brakes 22 (only two of which are shown), each having a brake caliper 24 having the brake cylinder, and a brake disk 26 as well as a unit 28 which is designed as an ESP unit (ESP: electronic stability program) for additional pressure buildup in braking system 12. Main cylinder 20 is hydraulically connected via brake booster 18 to actuating element 16, on the one hand, and is hydraulically connected to the brake cylinder of wheel brake 22 via brake lines 30 and braking system 12, on the other hand.

Compensation system 10 includes, in addition to unit 28, a sensor 32 for continuously or periodically ascertaining an instantaneous position of actuating element 16 in its adjustment travel and a device 34 for controlling and/or regulating the compensation as a function of this ascertained instantaneous position. For this purpose, device 34 additionally receives an input signal proportional to the instantaneous position of actuating element 16 (arrow). Device 34 optionally also receives an input signal proportional to the prepressure of braking system 12.

Braking system 12 has, in addition to unit 28, a main path, which is divided into one path per wheel brake 22. Each path has an inlet valve 36 and a bypass having an outlet valve 38, which opens into a shared return path 40, in which a storage unit 41 and a pump 42 designed as a return pump are situated.

The specific embodiment of unit 28 which is shown here as an example has a pump 42 and a switching valve 43 in the main path as well as an intake valve 44 in a path between the end of brake line 30 near the main cylinder and a section of return path 40 between pump 42 and storage unit 41. Pump 42 (return pump) is driven by engine M of the vehicle.

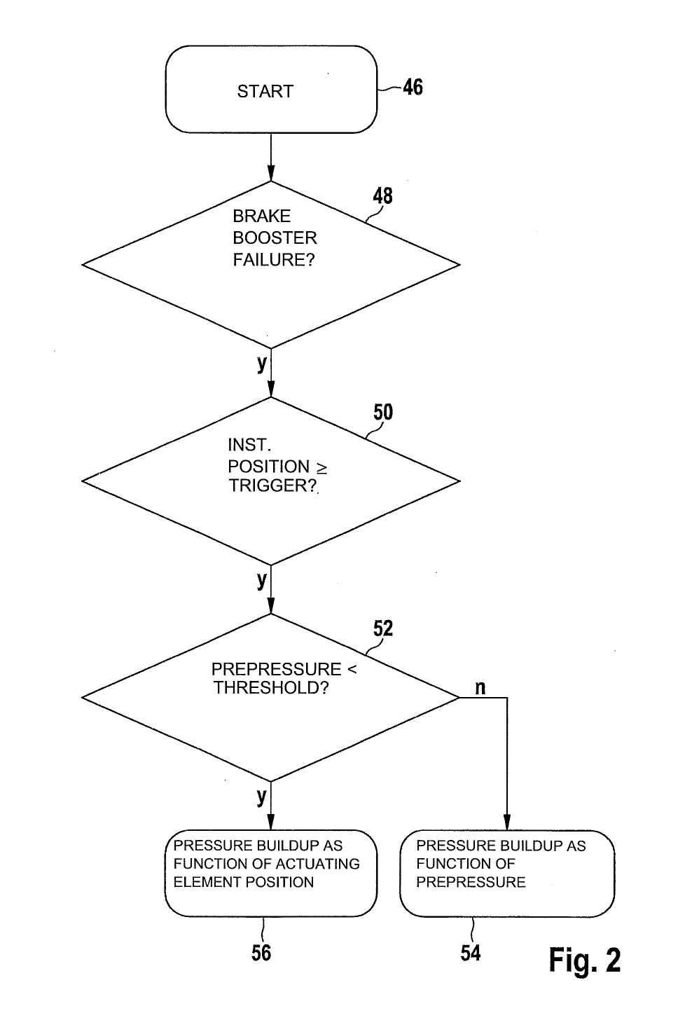

FIG. 2 shows a flow chart of the compensation method according to the present invention and in particular its triggering process. This yields the following function of system 10 shown in FIG. 1:

Beginning with a starting point 46, there is a first query 48, in which it is queried whether a malfunction or even a failure of brake booster 18 is detected (for example, by detecting a slight vacuum or a defect in the brake booster). If there is no failure or malfunction, no additional triggering criteria are queried and no compensation (an active pressure buildup) is triggered.

However, if there is such a failure or malfunction (path y), then it is queried in a subsequent second query 50 is whether the ascertained instantaneous position of actuating element 16 has reached or exceeded a predefinable triggering position, in particular a triggering position predefined by an adjustment, in the adjustment travel of actuating element 16. If this is not the case, no compensation is triggered.

However, if this position is reached or exceeded (path y), it is queried in a subsequent third query 52 whether the prepressure of braking system 12 is lower than a threshold value. If this is not the case (path n) and if the prepressure is greater than or equal to the threshold value, an active pressure buildup occurs in operation 54 with the aid of unit 28 as a function of the prepressure. If the prepressure of braking system 12 is lower than a threshold value (path y), an active pressure buildup occurs in operation 56 with the aid of unit 28 as a function of the ascertained position of actuating element 16 up to a predefinable maximum pressure, which corresponds to a tolerable deceleration of the vehicle.

Through the use of a redundant signal, the probability of faulty activation is limited. However, the intrinsic safety of the system may be increased by limiting the pressure buildup until reaching the previous pressure threshold.

As an additional safeguard, the pressure buildup may be limited in time only on the basis of the instantaneous position of actuating element 16 in its adjustment travel without taking the prepressure into account. However, the influence on the prepressure of braking system 12 due to the active pressure buildup is to be taken into account here.

Active pressure buildup is initiated after reaching/exceeding the triggering position. This triggering position may depend on the status of an offset adjustment—a lower threshold as soon as sensor 32 has been calibrated.

1.-11. (canceled)

12. A method for compensating an insufficient pressure buildup in a braking system of a motor vehicle, comprising:
performing a compensation with the aid of a unit to achieve an additional pressure buildup in the braking system;
triggering of the compensation as a function of a position of an actuating element in an adjustment travel of the actuating element; and
one of continuously and periodically ascertaining an instantaneous position of the actuating element in the adjustment travel, wherein the triggering and the additional pressure buildup occur as a function of the ascertained instantaneous position.

13. The method as recited in claim 12, wherein the motor vehicle is a motor vehicle in the event of one of a failure and a malfunction of a brake booster for a brake force support during an actuation of the actuating element of the braking system.

14. The method as recited in claim 12, wherein the compensation is triggered when the instantaneous position one of reaches and exceeds a predefinable triggering position in the adjustment travel.

15. The method as recited in claim 12, wherein the compensation occurs by a vehicle dynamics control system of a driver assistant system of the motor vehicle.

16. The method as recited in claim 12, wherein the compensation occurs as a function of a prepressure of the braking system.

17. The method as recited in claim 12, wherein the instantaneous position of the actuating element is ascertained via a sensor.

18. The method as recited in claim 12, further comprising:
limiting the additional pressure buildup after the triggering and during an adjustable period of time.

19. A system for compensating an insufficient pressure buildup in a braking system of a vehicle in the event of one of a failure and a malfunction of a brake booster for a brake force support during an actuation of an actuating element of the braking system, the system comprising:
a unit for achieving an additional pressure buildup in the braking system;
a sensor for one of continuously and periodically ascertaining an instantaneous position of the actuating element in an adjustment travel of the actuating element; and
a device for at least one of controlling and regulating the unit as a function of the ascertained instantaneous position.

20. The system as recited in claim 19, wherein the system is part of a driver assistance system of the vehicle.

21. The system as recited in claim 19, wherein the device for at least one of controlling and regulating the unit receives an input signal in proportion to a prepressure of the braking system.

22. The system as recited in 19, wherein:
the actuating element includes a pedal, and the sensor includes a pedal travel sensor.

23. A device, comprising:
an arrangement for compensating an insufficient pressure buildup in a braking system of a motor vehicle, comprising:
an arrangement for performing a compensation with the aid of a unit to achieve an additional pressure buildup in the braking system;
an arrangement for triggering the compensation as a function of a position of an actuating element in an adjustment travel of the actuating element; and an arrangement for, one of continuously and periodically, ascertaining an instantaneous position of the actuating element in the adjustment travel, wherein the triggering and the additional pressure buildup occur as a function of the ascertained instantaneous position.
